(19) United States
(12) Patent Application Publication
(10) Pub. No.: US 2026/0008443 A1
(43) Pub. Date: Jan. 8, 2026

(54) REAR PARKING COLLISION AVOIDANCE CONTROL DEVICE AND METHOD THEREFOR

(71) Applicant: HYUNDAI MOBIS CO., LTD., Seoul (KR)

(72) Inventor: Kang Hee Kim, Yongin-si (KR)

(73) Assignee: HYUNDAI MOBIS CO., LTD., Seoul (KR)

(21) Appl. No.: 19/224,304

(22) Filed: May 30, 2025

(30) Foreign Application Priority Data
Jul. 8, 2024 (KR) 10-2024-0089561

(51) Int. Cl. B60T 8/58; B60T 7/22; B60T 8/171; B60T 8/172

(52) U.S. Cl. CPC B60T 8/58; B60T 7/22; B60T 8/171; B60T 8/172; B60T 2201/022; B60T 2210/32

(57) ABSTRACT

An apparatus for performing rear parking collision avoidance of a vehicle is disclosed. The apparatus may include: a plurality of ultrasonic sensors; and a controller operatively connected to the plurality of ultrasonic sensors and configured to control braking and braking deceleration according to one or more sensor values obtained from the ultrasonic sensors. The controller may be configured to generate an obstacle detected according to the sensor values as a valid target; confirm the valid target as a braking target for the rear parking collision avoidance; and in response to that the valid target is confirmed as the braking target, perform braking control of the vehicle at a target deceleration determined according to a remaining distance between the vehicle and the braking target. The remaining distance corresponds to a target distance between the vehicle and the braking target after the braking control.

This application claims the benefit of Korean Patent Application No. 10-2024-0089561, filed on Jul. 8, 2024, which is hereby incorporated by reference as if fully set forth herein.

### BACKGROUND OF THE DISCLOSURE

### Field of the Disclosure

The embodiments of the present disclosure relate to a rear parking collision avoidance control device and a method for the same, and more particularly to a control device for performing braking required for rear collision avoidance of a vehicle when controlling parking of a vehicle, and a method for the same.

### Discussion of the Related Art

A rear parking collision avoidance assist system is an advanced driver assistance system that automatically performs braking when a vehicle (i.e., a host vehicle) is moving backward (is backing up) in a parking mode, so that the rear parking collision avoidance assist system can prevent collision with a person, object, or peripheral vehicles located behind the host vehicle. The rear parking collision avoidance assist system is very useful when the host vehicle moves backward in a parking lot or in a tight space, and helps prevent collision accidents.

The rear parking collision avoidance assist system detects a person, object, or peripheral vehicles located behind the host vehicle using ultrasonic, radar, lidar, or image sensors, and outputs a warning message to the driver or performs braking control based on the result of such detection.

The present disclosure proposes more effective braking control in relation to the rear parking collision avoidance assist system.

### SUMMARY OF THE DISCLOSURE

In accordance with the aforementioned background, an object of the present disclosure is to provide a rear parking collision avoidance control device and a method for the same.

Technical subjects to be solved by the present disclosure are not limited to the above-mentioned technical solutions, and it should be noted that other technical subjects not described above can be understood by those skilled in the art from the description of the present disclosure below.

In accordance with an embodiment of the present disclosure, an apparatus for performing rear parking collision avoidance of a vehicle is disclosed. The apparatus may include: a plurality of ultrasonic sensors; and a controller operatively connected to the plurality of ultrasonic sensors and configured to control braking and braking deceleration according to one or more sensor values obtained from the ultrasonic sensors. The controller may be configured to generate an obstacle detected according to the sensor values as a valid target; confirm the valid target as a braking target for the rear parking collision avoidance; and in response to that the valid target is confirmed as the braking target, perform braking control of the vehicle at a target deceleration determined according to a remaining distance between the vehicle and the braking target. The remaining distance corresponds to a target distance between the vehicle and the braking target after the braking control.

In accordance with another embodiment of the present disclosure, there is proposed a method for performing rear parking collision avoidance of a vehicle by a rear parking collision avoidance device that includes a plurality of ultrasonic sensors, and a controller operatively connected to the plurality of ultrasonic sensors and configured to control braking and braking deceleration according to one or more sensor values obtained from the ultrasonic sensors. The method may include: generating an obstacle detected according to the sensor values as a valid target; confirming the valid target as a braking target for rear parking collision avoidance; and in response to that the valid target is confirmed as the braking target, performing braking control of the vehicle at a target deceleration determined according to a remaining distance between the vehicle and the braking target, wherein the remaining distance corresponds to a target distance between the vehicle and the braking target after the braking control.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 is an overall block diagram illustrating an autonomous vehicle to which an autonomous driving apparatus can be applied.

FIG. 2 is a schematic diagram illustrating an example vehicle to which an autonomous driving apparatus is applied.

FIG. 3 is a diagram illustrating the existing PCA method in a rear parking process and the inventive collision avoidance assist method in a rear parking process according to the present disclosure.

FIG. 4 is a diagram illustrating a method of comparing distribution of the probability of recognizing ultrasonic signals of the ultrasonic sensor of the present disclosure with conventional ultrasonic signals of the related art.

FIG. 5 is a flowchart illustrating a method for performing rear parking collision avoidance according to the present disclosure.

FIG. 6 is a graph illustrating the function f(v) according to the vehicle speed (v) with respect to the deceleration (a).

FIG. 7 is a flowchart illustrating a method for performing rear parking collision avoidance according to the present disclosure.

FIG. 8 is a block diagram illustrating a control device for performing rear parking collision avoidance according to the present disclosure.

### DETAILED DESCRIPTION OF THE DISCLOSURE

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the specification, when a part “includes” an element, it means that the part may further include another element rather than excluding another element unless otherwise mentioned.

In addition, in the specification, “occupant”, “passenger”, “driver”, “user”, etc. are mentioned for description of the present disclosure, and may be used interchangeably therewith.

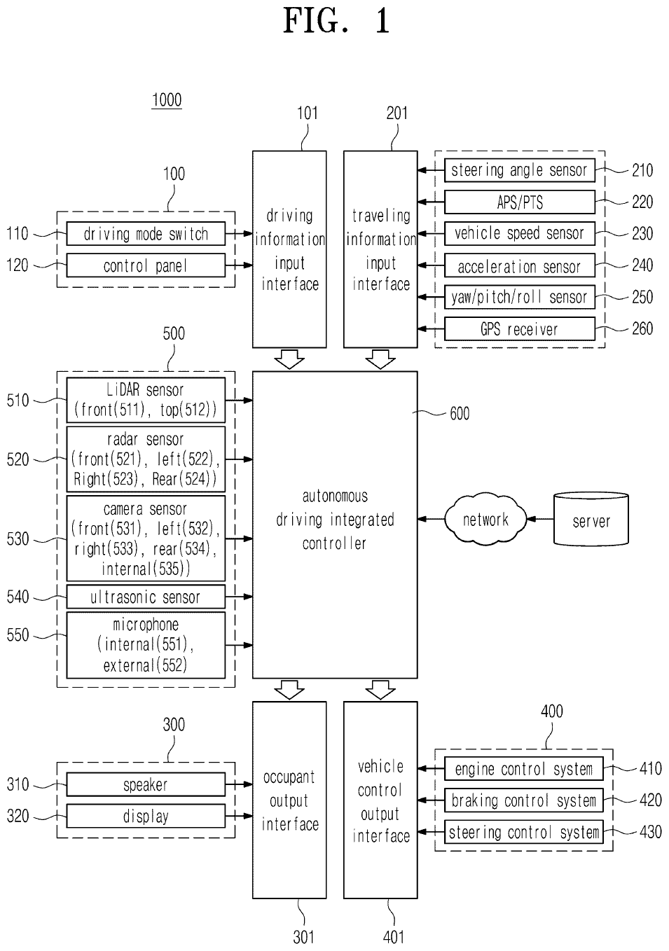

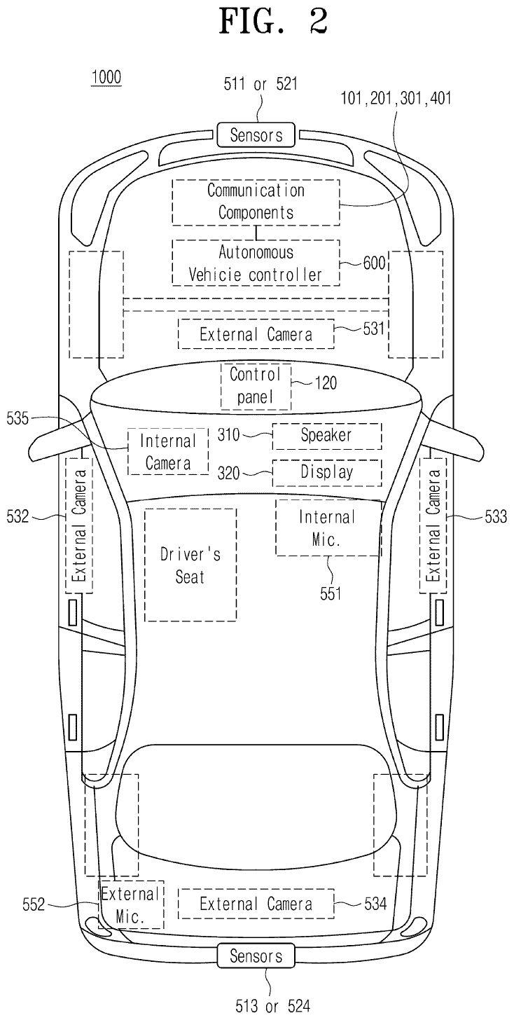

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

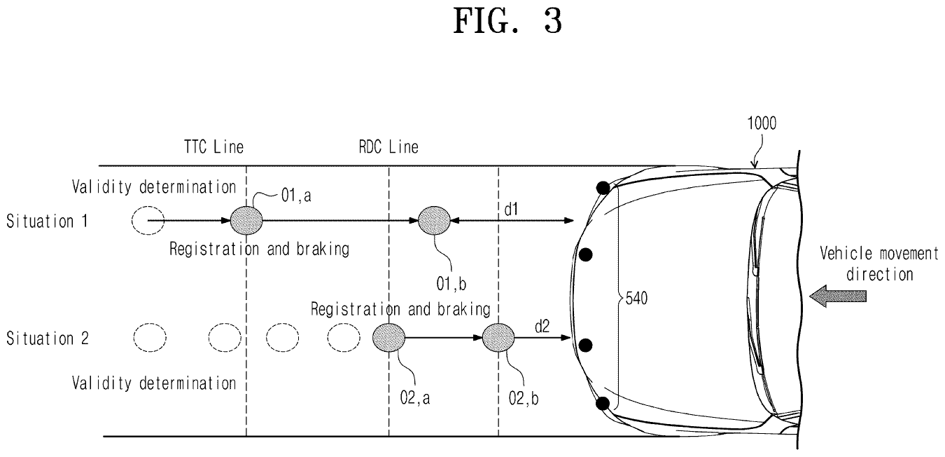

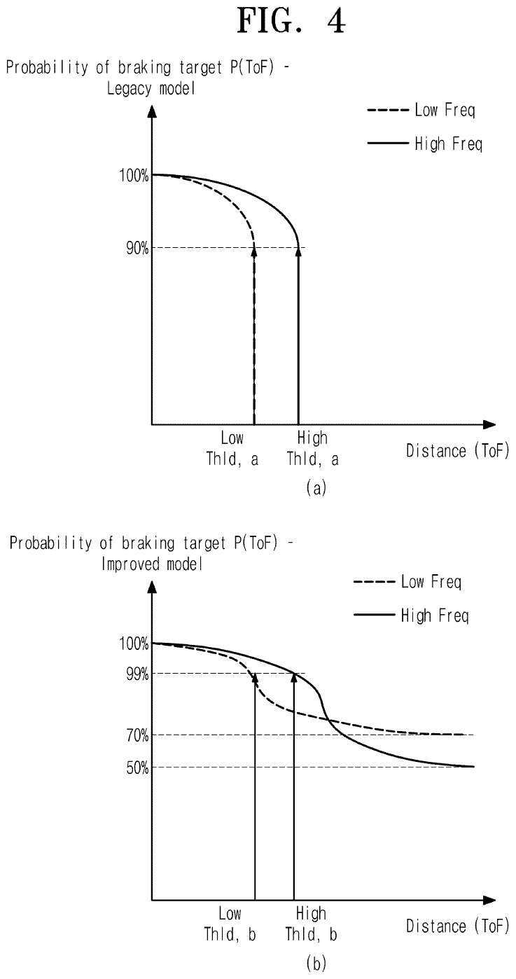

FIG. 3 is a diagram illustrating the existing PCA (rear parking collision avoidance assist) method in a rear parking process and the inventive collision avoidance assist method in a rear parking process according to the present disclosure. FIG. 4 is a diagram illustrating a method of comparing distribution of the probability of recognizing ultrasonic signals of the ultrasonic sensor of the present disclosure with conventional ultrasonic signals of the related art.

Referring to FIG. 3, a rear end (tail portion) of the vehicle 1000 is illustrated. More specifically, the rear end of the vehicle 1000 corresponds to a rear bumper of the vehicle, and a plurality of ultrasonic sensors 540 is provided therein.

As illustrated, the vehicle 1000 is illustrated as moving backward to the left. The upper part of FIG. 3 illustrates a time to collision (TTC) line and a remaining distance control (RDC) line. In FIG. 3, generation of valid targets, determination of braking targets, and braking control using the conventional TTC are illustrated, and generation of valid targets, determination of braking targets, and braking control using the RDC line are illustrated.

Situation 1 represents rear parking collision avoidance control along the TTC line, and situation 2 represents rear parking collision avoidance control along the RDC line.

Compared to the control method according to the existing TTC line, the control method according to the RDC line of the present disclosure is as follows. In the control method according to the present disclosure, after completion of braking control, a distance between the vehicle 1000 and the obstacle (O1) is d1, a distance between the vehicle 1000 and the obstacle (O2) is d2, and the distance between the obstacle and the vehicle according to the control method based on the RD line is relatively short. This is because the braking control is performed targeting the remaining distance, and the background of such braking control is explained as follows.

Meanwhile, in the present specification, objects, people, etc. detected by the ultrasonic sensor are simply referred to as obstacles.

The conventional PCA provides braking control according to the TTC line, detects and recognizes peripheral obstacles using the ultrasonic sensor and the camera sensor, and then performs braking control when there is a risk of collision. For example, according to the rear parking collision avoidance assist (PCA) method, when the TTC is determined to be 0.8 seconds or less, braking control is performed. According to another PCA method using only the ultrasonic sensor, a maximum speed performance is approximately 5 kph.

However, the conventional PCA has the following problems. In the following description, the size of indirect waves or the indirect waves can be expressed as a distance value (e.g., 1.1 m), which means the distance to the reflection point (i.e., obstacle) of the indirect waves measured based on the time of flight (ToF) of the indirect waves. That is, in the present specification, the size of the indirect waves and the amplitude of the indirect waves have different meanings.

### \textcircled{1} Improper Braking Problem

The PCA method performs control based on the TTC line, and is designed to determine coordinates (i.e., create a valid target) when the indirect waves (or the ToF based on the indirect waves) are received within a tuning value (1.1 m), and perform braking control when the time-to-collision (TTC) time with the corresponding coordinates is within 0.8 seconds. The PCA method tunes the indirect waves so that the indirect waves are not detected below the tuning value (1.1 m) for non-valid or invalid (non-braking) targets. The tuning value refers to a reference value for comparison with either the distance measured using the ToF of the indirect waves or the amplitude of the indirect waves.

However, depending on the environment, indirect waves below the tuning value may be detected in many cases, such as parking blocks, low curbs, and general parking environments. Currently, indirect waves within 1.1 m must be consecutively received 2 to 3 times for determination of coordinates, but the improper braking problem still exists, and if the number of consecutive receptions is increased to prevent improper braking, the problem of reduced response speed occurs.

### \textcircled{2} Non-Braking Problem (Problem Caused by Low Response Speed)

If indirect waves with a value greater than the tuning value (1.1 m) are introduced, the coordinates are not determined, so that there is a limit to the response speed.

### \textcircled{3} a Unified Braking Deceleration

The target deceleration is unified according to the current speed. That is, only one deceleration is provided in a specific speed section. A detailed description thereof is shown in the following table.

TABLE 1

| | |
|---|---|
| Speed Range | PCA_Dc1TrgtVal |

| | | |
|---|---|---|
| 0~2 | kph | 0.16 g |
| 2~4 | kph | 0.20 g |
| 4~6 | kph | 0.20 g |
| 6~8 | kph | 0.28 g |
| 8~10 | kph | 0.32 g |

Accordingly, when a suddenly detected obstacle (target) cuts in or when a target is recognized later due to noise, the existing PCA method is unable to flexibly cope with the detected obstacle or target.

\textcircled{4} Quality Problem of Irregular Distance Between Bumper and Object after Braking

Depending on the driving speed and environment, the problem of irregular distance after braking occurs, resulting in quality problems. Since the point of target recognition may vary depending on the situation, the distance after braking also varies.

In contrast, the proposed RDC line method is as follows.

\textcircled{1} According to the present disclosure, the conventional TTC line-based control method is changed to the RDC line-based control method, so that the probability of improper braking can be significantly reduced while increasing the response speed.

The proposed method is designed to perform braking control at the same time as confirming the target coordinates (i.e., confirming the braking target) when the distance between the obstacle and the vehicle bumper is determined to be RD (tuning value, e.g., 25 cm) after braking and stopping of the vehicle. Here, RD (remaining distance) refers to the distance between the obstacle and the vehicle bumper after braking is completed, and is referred to as “remaining distance” hereinafter. In addition, although the vehicle bumper will be a criterion (standard) for the remaining distance, it is simply expressed as the (remaining) distance between the vehicle and the obstacle in the present specification.

This can significantly reduce the probability of improper braking by delaying the braking time compared to the conventional method. For example, at a speed of 3 kph, the indirect waves are measured to be about 0.6 m at the time of coordinate confirmation, and at a speed of 4.5 kph, the indirect waves are measured to be about 0.8 m at the time of coordinate confirmation. According to FIG. 4(b), when the distance (ToF) is 0.8 m (HighThld, b), the probability of a braking (valid) target is about 99%, so that the probability of improper braking is only about 1%.

\textcircled{2} According to the present disclosure, the ultrasonic tuning method is changed to FIG. 4(b) to increase the probability that the detected obstacle is a braking target.

FIG. 4(a) shows the probability of a braking target according to the existing model, and shows the probability of a braking target according to the size (ToF) of the indirect waves. For example, when high-frequency ultrasonic waves (High Freq) are used, it is determined that there is a 90% probability at the threshold (HighThld, a), which may be based on the result of confirming or simulating that indirect waves having the size up to the threshold correspond to a braking target with a 90% probability by considering the amplitude of the indirect waves.

FIG. 4(b) illustrates the probability of a braking target by the model according to the present disclosure, and illustrates the probability of a braking target according to the size (ToF) of the indirect waves. What is to be achieved by the model according to the present invention is to have a higher probability for larger indirect waves compared to existing models. Accordingly, the threshold (HighThld,b, LowThld,b) is greater than the threshold (HighThld,a, LowThld,a), and the probability thereof is also higher than that of the model (90%→99%). To this end, the amplitude of indirect waves to be determined as a valid detection can be further increased, and accordingly, in the present disclosure, indirect waves with a higher amplitude range can be treated as valid indirect waves compared to the related art.

Hereinafter, the proposed RDC line method-based rear parking collision avoidance control will be described in more detail.

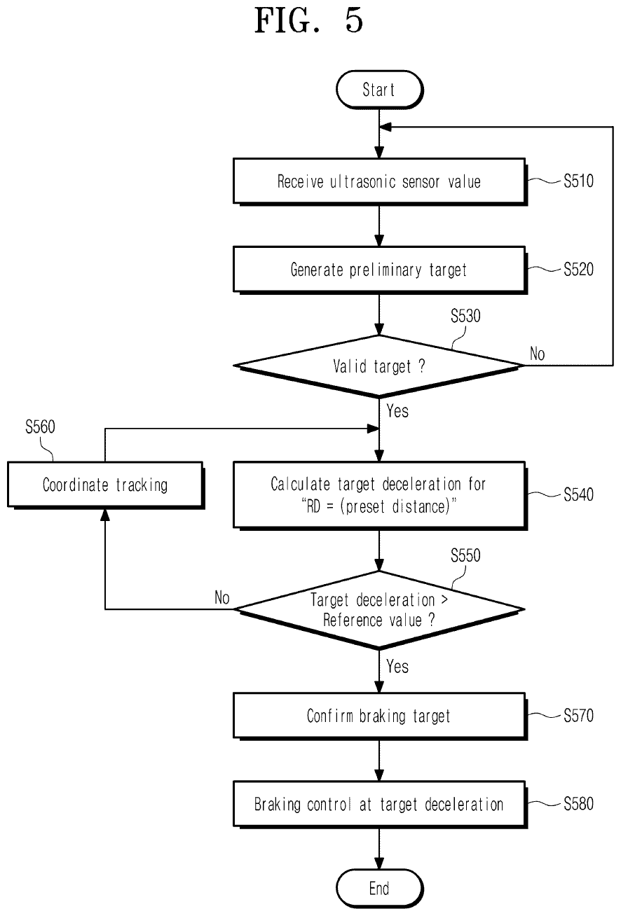

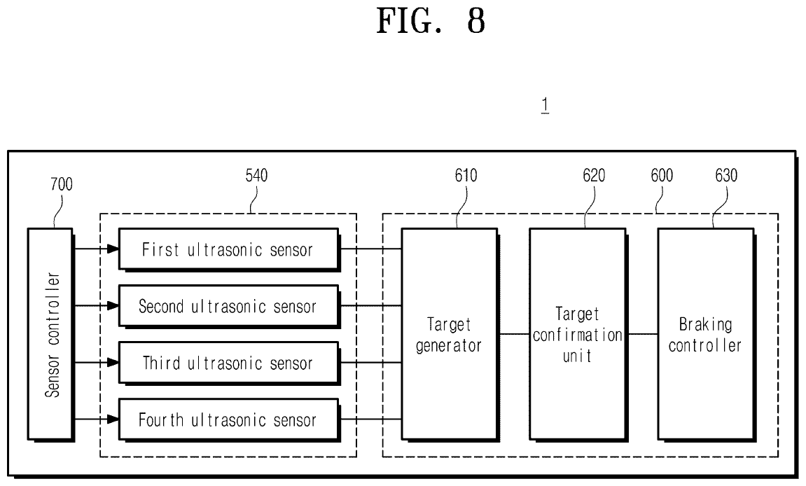

FIG. 5 is a flowchart illustrating a method for rear parking collision avoidance according to the present disclosure. The control method for rear parking collision avoidance illustrated in FIG. 5 may be performed by the control device 1 for rear parking collision avoidance. The control device 1 will be described later with reference to FIG. 8. Hereinafter, for simplicity of description, the method of FIG. 5 will be described as being performed by a “device.”

The device may receive a sensor value obtained from the ultrasonic sensor (S510). The sensor value may be referred to by various names and may include a distance calculated from ToF.

The device may generate a preliminary target based on the sensor value (S520). The device may generate a preliminary target corresponding to an obstacle using the sensor value, and may obtain the coordinate value thereof. The coordinate value may be generally obtained using a sensor value obtained from the ultrasonic sensor, for example, an intersection of one direct wave and two indirect waves.

The device may determine whether the generated preliminary target is a valid target (S530).

Whether a preliminary target is a valid target may be determined by whether the following several determination conditions are satisfied. That is, if the following several conditions are satisfied, the device may determine that the preliminary target is a valid target.

The following three conditions are described, and at least one of these conditions may be used to determine the validity of the preliminary target (i.e., whether it is a valid target).

### First Condition

$$Q ( TOF ) = \prod ( 1 - P ( {TOF}_{n} ) ) < 1 \% \qquad [ Equation 1 ]$$

In Equation 1, P(ToFn) means the probability that the N-th obtained ultrasonic sensor value (ToF) is a valid target. Accordingly, 1-P(ToFₙ) means the probability that the N-th obtained ultrasonic sensor value (ToF) is an invalid (invalid or non-valid) target.

That is, Equation 1 means that the probability that all of the multiple obtained ultrasonic sensor values are invalid targets is less than 1%, or conversely, the probability that at least one of the multiple obtained ultrasonic sensor values is a valid target is greater than 99%.

In other words, this means that the probability that at least one of the continuously introduced ToF values indicates a valid target is greater than 99%.

When Equation 1 is satisfied, the device may determine the preliminary target corresponding to the obtained ultrasonic sensor value as a valid target.

Meanwhile, referring to FIG. 4(b), in a situation where high-frequency (High Freq) ultrasonic waves are used, if the ToF value is less than the threshold value (High Thld), the probability (P(ToF)) exceeds 99%. Accordingly, if the obtained ultrasonic sensor value is less than the corresponding ToF value (i.e., the threshold value “High Thld”), the device may determine the preliminary target corresponding to the obtained ultrasonic sensor value as a valid target.

### Second Condition

$$P ( t ) - {P}_{track} ( t ) < Threshold \qquad [ Equation 2 ]$$

In Equation 2, P(t) is denoted by P(t)=[x(t), y(t)], which means the coordinates generated at the current time point), and P_{track}(t)=[x_tr(t), y_tr(t)], which means a value obtained by tracking the coordinates generated at the previous time point.

That is, if the actual coordinates of the preliminary target based on the ultrasonic sensor values obtained (received) at the current time point and the predicted coordinates of the preliminary target based on the ultrasonic sensor values obtained (received) just before the current time point are less than a threshold, the device may determine the preliminary target corresponding to the obtained ultrasonic sensor values as a valid target. Here, the threshold may be 20 cm.

### Third Condition

The amplitude tendency of the ultrasonic sensor values can be utilized.

In the case of a valid target, the probability of satisfying the following conditions is high.

(Condition 3-1) The smaller the ToF at the time of ToF update, the greater the amplitude.

(Condition 3-2) If the current ToF is less than the previously updated ToF, the amplitude increases.

Therefore, if the condition (3-1) or (3-2) is satisfied, the device may determine the preliminary target corresponding to the obtained ultrasonic sensor value as a valid target.

Referring back to FIG. 5, when a valid target is not generated, the device may receive the ultrasonic sensor value again (S510).

When a valid target is generated, the device may calculate the target deceleration required for the remaining distance (RD) to the valid target to reach a preset distance (e.g., 25 cm) (S540). At this time, additionally required information is the distance (s) between the vehicle and the valid target (obstacle) and the driving speed (v) of the vehicle.

Assuming that the vehicle is traveling at a constant speed, the target deceleration (a) can be determined as follows.

$$α ( v , s ) = \frac{{v}^{2}}{2 ( s - RD )} \qquad [ Equation 3 ]$$

The device may determine whether the target deceleration exceeds a reference value (e.g., 0.2 g) (S550).

The comparison between the target deceleration and the reference value may be expressed as follows.

$${α}_{RD = 25 cm} ( s , v ) > 0.2 g \qquad [ Equation 4 ]$$

Equation 4 means that the deceleration (α_{RD}=25 cm) that enables the remaining distance (RD) measured at the separation distance (s) and the driving speed (v) at the valid target determination time point to be 25 cm exceeds 0.2 g. The device may determine the coordinates or obstacles corresponding to the obtained ultrasonic sensor values as valid targets if the deceleration (α_{RD}=25 cm) that enables the remaining distance (RD) measured at the separation distance (s) and the driving speed (v) at the valid target determination time point to be 25 cm exceeds 0.2 g

Meanwhile, the deceleration of 0.2 g is a value obtained by an experimental value, and the deceleration of a vehicle in a parking environment generally ranges from 0 to 0.5 g. The function (f(v)) defining the difference between the RDC line and the TTC line can be defined as follows.

$$\begin{matrix}f ( v ) = RDCLine - TTCLine \\ = ( \frac{{v}^{2}}{2 α} + RD ) - ( TTC * v )\end{matrix} \qquad [ Equation 5 ]$$

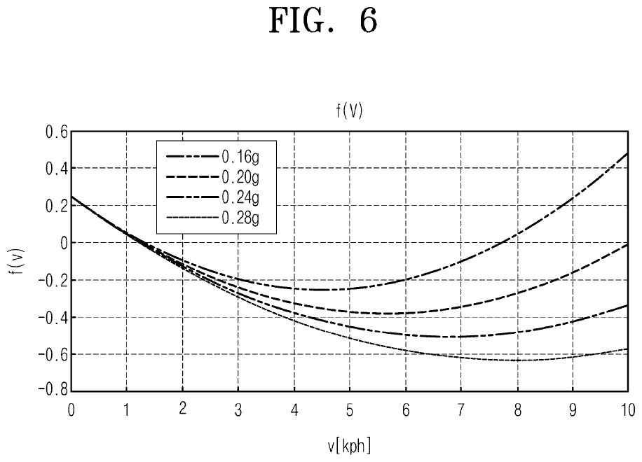

The purpose of the present disclosure is to allow the remaining distance (RD) to be shorter than the distance (d1) after braking in the PCA method according to the existing TTC line or to allow the remaining distance (RD) to be constant. Here, the value of f(v) must be a negative (−) value. FIG. 6 is a graph showing f(v) according to the vehicle speed (v) with respect to the deceleration (a). Referring to FIG. 6, it can be confirmed that the deceleration of 0.2 g maintains the value of f(v) in the negative range in the speed range (e.g., 1 to 10 kph) in the parking environment of the vehicle. However, the deceleration of 0.2 g may be selected as a different value depending on the vehicle driving speed (v) during vehicle parking.

If the target deceleration does not exceed the reference value, the device may track the coordinates of the valid target (S560). At this time, the device may additionally obtain ultrasonic sensor values. In addition, the device may use the additionally obtained ultrasonic sensor values for tracking the coordinates of the valid target.

If the target deceleration exceeds the reference value, the device may confirm the valid target as the braking target (S570).

The confirmation of the braking target can be determined as the target deceleration value according to S550. That is, if the target deceleration value is greater than the reference value, the device may confirm the valid target as the braking target.

Alternatively, in order to confirm the braking target, the device may determine whether a valid target (i.e., an obstacle) exists on the driving path of the vehicle before performing the braking control, and if the valid target exists on the driving path, the device may determine the valid target as the braking target.

Thereafter, the device may perform the braking control with the target deceleration (S580).

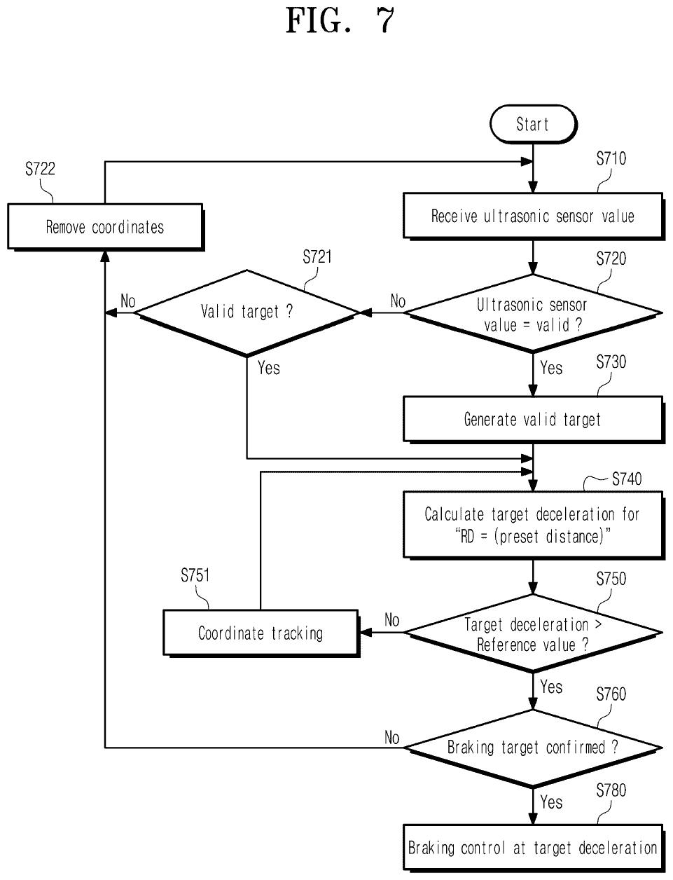

FIG. 7 is a flowchart illustrating a method for performing rear parking collision avoidance according to the present disclosure.

The control method for performing rear parking collision avoidance illustrated in FIG. 7 may be performed by the control device 1 for rear parking collision avoidance. The control device 1 will be described later with reference to FIG. 8. Hereinafter, for simplicity of description, the method of FIG. 7 will be described as being performed by a “device.”

The device may receive a sensor value obtained from the ultrasonic sensor (S710). The sensor value may be referred to by various names and may include a distance calculated from the ToF.

The device may determine whether the obtained sensor value (i.e., the ToF value) is a valid value (S720). More specifically, the device may determine whether the probability P(ToF) of the ultrasonic sensor value being a valid target exceeds a preset probability (e.g., 99%) or whether the ultrasonic sensor value is less than the ToF value of the preset probability. That is, the device may determine whether the corresponding obstacle is a valid target based on the obtained ultrasonic sensor value.

If the ultrasonic sensor value is not a valid value, the device may determine whether the obstacle corresponding to the obtained sensor value is a valid target (S721). More specifically, the device may generate a preliminary target, generate coordinates of the preliminary target, and/or determine whether the preliminary target is a valid target.

At this time, at least one of Conditions 1 to 3 described above can be used to determine whether the preliminary target is a valid target. If at least one of Conditions 1 to 3 is satisfied, the device may proceed to S740.

If it is determined that the preliminary target is not a valid target, the device may remove the coordinates of the generated preliminary target (S722).

If the probability that the ultrasonic sensor value is a valid target exceeds a preset probability or the ultrasonic sensor value is less than the ToF value of the preset probability, the device may generate a valid target and/or generate coordinates of the valid target (S730).

Then, the device may calculate the target deceleration for the remaining distance (RD) to become a preset distance (e.g., 25 cm) for the valid target (S740). At this time, additionally required information is the distance (s) between the vehicle and the obstacle and the driving speed (v) of the vehicle. For calculation of the target deceleration, refer to Equation described above.

The device may determine whether the target deceleration exceeds a reference value (e.g., 0.2 g) (S750). If the target deceleration does not exceed the reference value, the device may track the coordinates of the valid target (S751).

Then, the device may determine whether to confirm the valid target as a braking target (S760).

The determination of the braking target may be determined as the target deceleration value according to S750. That is, if the target deceleration value is greater than the reference value, the device may determine the valid target as the braking target.

Alternatively, in order to determine the braking target, the device may determine whether a valid target (i.e., an obstacle) exists on the driving path of the vehicle before performing the braking control, and if the valid target exists on the driving path, the device may determine the valid target as the braking target.

If the valid target is not determined as the braking target, the device may remove the coordinates of the valid target (S722).

If it is determined that the valid target is on the driving path, the device may perform the braking control at the target deceleration (S770).

Descriptions related to devices that are not described with reference to FIG. 7 will be described with reference to FIGS. 3 to 6.

FIG. 8 is a block diagram illustrating the control device for performing rear parking collision avoidance according to the present disclosure.

The control device 1 may include a controller 600 configured to perform braking control, an ultrasonic sensor 540, and a sensor controller 700.

The sensor controller 700 may control the ultrasonic sensor 540. The sensor controller 700 may adjust or tune the characteristics of ultrasonic waves transmitted from the ultrasonic sensor 540. In addition, the sensor controller 700 may control the ultrasonic wave transmission time point of the ultrasonic sensor 540.

The controller 600 may include a target generator 610, a target confirmation unit 620, and a braking controller 630.

The target generator 610 may process a sensor value obtained from the ultrasonic sensor 540. For example, the target generator 610 may calculate a ToF value from the sensor value.

The target generator 610 may determine whether to generate a detected obstacle as a valid target based on the sensor value.

In addition, the target generator 610 may generate the detected obstacle as a valid target based on the probability that the detected obstacle is a valid braking target. The target generator 610 may accumulate and receive ultrasonic sensor values for the detected obstacle until the probability value becomes higher than a preset value.

Meanwhile, the target generator 610 may generate the detected obstacle as a valid target based on other conditions or determination criteria. For other conditions or determination criteria for deciding a valid target, refer to Conditions 1 to 3 described above.

The target confirmation unit 620 may determine whether to confirm the valid target as a braking target for the rear parking collision avoidance.

The target confirmation unit 620 may determine the valid target as a braking target based on the target remaining distance (RD) to the valid target. In addition, the target confirmation unit 620 may obtain a target deceleration for enabling the target remaining distance (RD) to become a preset distance value, and if the obtained target deceleration is greater than the preset deceleration, the target confirmation unit 620 may determine the valid target as a braking target.

As the braking controller 630 is determined as a braking target, the braking controller 630 may perform braking control at a target deceleration. In this case, the target deceleration is determined according to at least the remaining distance between the vehicle and the braking target, and the remaining distance corresponds to a target distance between the vehicle after braking according to the braking control and the braking target.

In addition, the target deceleration may be additionally determined according to the distance between the detected braking target and the vehicle at the time of obtaining the target deceleration.

For details related to the device 1 not described with reference to FIG. 8, reference may be made to the description related to FIGS. 3 to 7, and the content thereof can be applied to the device 1 of FIG. 8.

Meanwhile, as another embodiment of the present disclosure, a vehicle 1000 including the above-described device 1 is proposed.

Although the above-described embodiments of the present disclosure have disclosed that the device (or system) for preventing collision in rear-end parking of a vehicle, and components included the device or system perform such control for convenience of description, the device (or system) and the components belonging thereto are names only and the scope of rights is not dependent thereon.

In other words, the proposed technology of the present disclosure may be performed by devices having names other than the processor, controller, etc. In addition, the method, scheme, or the like described above may be performed by software or code readable by a computer or other machine or device for vehicle control.

In addition, as another aspect of the present disclosure, the operation of the proposed technology described above may be provided as code that may be implemented, realized, or executed by a “computer” (a generic concept including a system on chip (SoC) or a (micro) processor) or a computer-readable storage medium, a computer program product, or the like storing or containing the code. The scope of the present disclosure is extendable to the code or the computer-readable storage medium or the computer program product storing or containing the code.

Detailed descriptions of preferred embodiments of the present disclosure disclosed as described above have been provided such that those skilled in the art may implement and realize the present disclosure.

Although the present disclosure has been described above with reference to preferred embodiments, those skilled in the art will understand that various modifications and changes can be made to the present disclosure set forth in the claims below.

Accordingly, the present disclosure is not intended to be limited to the embodiments shown herein but is to be accorded the widest scope consistent with the principles and novel features disclosed herein.

As is apparent from the above description, the embodiments of the present disclosure have the following effects.

The embodiments of the present disclosure may perform vehicle braking to prevent rear-end collision.

In addition, the present disclosure can obtain a result with a reduced probability of improper braking compared to the existing PCA (parking collision avoidance assist) system.

In addition, the present disclosure can perform braking control up to a driving speed of 10 km per hour using only an ultrasonic sensor, thereby satisfying performance of the existing PCA (parking collision avoidance assist) system without using the images.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. An apparatus for performing rear parking collision avoidance of a vehicle, the apparatus comprising:
a plurality of ultrasonic sensors; and
a controller operatively connected to the plurality of ultrasonic sensors and configured to control braking and braking deceleration according to one or more sensor values obtained from the ultrasonic sensors,
wherein the controller is further configured to:
generate an obstacle detected according to the one or more sensor values as a valid target;
confirm the valid target as a braking target for the rear parking collision avoidance; and
in response to that the valid target is confirmed as the braking target, perform braking control of the vehicle at a target deceleration determined according to a remaining distance between the vehicle and the braking target,
wherein the remaining distance corresponds to a target distance between the vehicle and the braking target after the braking control.

2. The apparatus according to claim 1, wherein the controller is further configured to:
generate the detected obstacle as the valid target based on a probability that the detected obstacle is a valid braking target.

3. The apparatus according to claim 1, wherein the controller is further configured to:
accumulate and process ultrasonic sensor values for the detected obstacle until the probability value exceeds a preset value.

4. The apparatus according to claim 1, wherein the controller is further configured to:
confirm the valid target as the braking target based on a target remaining distance to the valid target.

5. The apparatus according to claim 4, wherein the controller is further configured to:
obtain the target deceleration required for the target remaining distance to reach a preset distance value; and
based on that the obtained target deceleration is higher than a preset deceleration, confirm the valid target as the braking target.

6. The apparatus according to claim 1, wherein the target deceleration is additionally determined based on a distance between the braking target and the vehicle at a time of obtaining the target deceleration.

7. A vehicle including the apparatus for performing the rear parking collision avoidance according to claim 1.

8. A method for performing rear parking collision avoidance of a vehicle by a rear parking collision avoidance device that includes a plurality of ultrasonic sensors, and a controller operatively connected to the plurality of ultrasonic sensors and configured to control braking and braking deceleration according to one or more sensor values obtained from the ultrasonic sensors, the method comprising:
generating, by the controller, an obstacle detected according to the one or more sensor values as a valid target;
confirming, by the controller, the valid target as a braking target for the rear parking collision avoidance; and
in response to that the valid target is confirmed as the braking target, performing, by the controller, braking control of the vehicle at a target deceleration determined according to a remaining distance between the vehicle and the braking target,
wherein the remaining distance corresponds to a target distance between the vehicle and the braking target after the braking control.

9. The method according to claim 8, further comprising:
generating, by the controller, the detected obstacle as the valid target based on a probability that the detected obstacle is a valid braking target.

10. The method according to claim 8, further comprising:
accumulating and processing, by the controller, ultrasonic sensor values for the detected obstacle until the probability value exceeds a preset value.

11. The method according to claim 8, further comprising:
confirming, by the controller, the valid target as the braking target based on a target remaining distance to the valid target.

12. The method according to claim 11, further comprising:
obtaining, by the controller, the target deceleration required for the target remaining distance to reach a preset distance value; and
based on that the obtained target deceleration is higher than a preset deceleration, confirming, by the controller, the valid target as the braking target.

13. The method according to claim 8, wherein the target deceleration is additionally determined based on a distance between the braking target and the vehicle at a time of obtaining the target deceleration.
